(19) United States
(12) Patent Application Publication
(10) Pub. No.: US 2015/0287339 A1
(43) Pub. Date: Oct. 8, 2015

(54) METHODS AND SYSTEMS FOR IMPARTING TRAINING

(71) Applicant: Xerox Corporation, Norwalk, CT (US)

(72) Inventors: Om D. Deshmukh, Bangalore (IN); Kuldeep Yadav, Gurgaon (IN); Shourya Roy, Bangalore (IN)

(73) Assignee: Xerox Corporation, Norwalk, CT (US)

(21) Appl. No.: 14/244,926

(22) Filed: Apr. 4, 2014

(51) Int. Cl. G09B 19/04; G10L 25/48

(52) U.S. Cl. CPC G09B 19/04; G10L 25/48

(57) ABSTRACT

The disclosed embodiments illustrate methods and systems for imparting a spoken language training. The method includes performing a spoken language evaluation of a speech input received from a user on a first training content. Thereafter, the user is categorized based on the spoken language evaluation and a profile of the user. Further, a second training content, comprising one or more tasks, is transmitted to the user based on the categorization and the spoken language evaluation. The user interacts with another user belonging to at least the user group, by comparing a temporal progression of the user with the other user on the one or more tasks, challenging the other user on a task from the one or more tasks, and selecting the task from the one or more tasks based on a difficulty level assessed by the other user.

### TECHNICAL FIELD

The presently disclosed embodiments are related, in general, to training to a user. More particularly, the presently disclosed embodiments are related to methods and systems for imparting spoken language training.

### BACKGROUND

In the recent years, growth and advancements in IT technology have led to a steady expansion in the market for education through IT-based technology. Several academic institutions and third-party experts/trainers have tapped into this growing market by offering online solutions for training and development. For example, spoken language training may be imparted through an online/e-learning (electronic) mode.

Although, the online/e-learning mode of training may be convenient for users, however training content offered through the online/e-learning mode may not be relevant as per an individual's specific training needs. Further, the online/e-learning mode may lack user interactivity. Thus, as compared to other modes of study such as class-room lectures, group/peer study, etc.; the online/e-learning mode may not as such be intrinsically motivating for the users. Hence, there is a need for a solution that overcomes the aforementioned issues in imparting training through the online/e-learning mode.

### SUMMARY

According to embodiments illustrated herein, there is provided a method for imparting a spoken language training. The method includes performing, by one or more processors, a spoken language evaluation of a speech input received from a user on a first training content. The spoken language evaluation corresponds to an evaluation of the speech input with respect to a pronunciation, a prosody, an intonation, a spoken grammar, and a spoken fluency. Further, the user is categorized in a user group from one or more user groups by the one or more processors, based on the spoken language evaluation and a user profile of the user. Thereafter, a second training content is transmitted to the user by the one or more processors, based at least on the categorization and the spoken language evaluation, wherein the second training content comprises one or more tasks for the spoken language training of the user. Further, the user interacts with at least one other user who belongs to at least the user group. The interaction comprises comparing a temporal progression of the user with the at least one other user on the one or more tasks, challenging the at least one other user on a task from the one or more tasks, and selecting the task from the one or more tasks based at least on a difficulty level of the task assessed by the at least one other user.

According to embodiments illustrated herein, there is provided a system for imparting a spoken language training. The system includes one or more processors that are operable to perform a spoken language evaluation of a speech input received from a user on a first training content. The spoken language evaluation corresponds to an evaluation of the speech input with respect to a pronunciation, a prosody, an intonation, a spoken grammar, and a spoken fluency. Further, the user is categorized in a user group from one or more user groups based on the spoken language evaluation and a user profile of the user. Thereafter, a second training content is transmitted to the user based at least on the categorization and the spoken language evaluation, wherein the second training content comprises one or more tasks for the spoken language training of the user. Further, the user interacts with at least one other user who belongs to at least the user group. The interaction comprises comparing a temporal progression of the user with the at least one other user on the one or more tasks, challenging the at least one other user on a task from the one or more tasks, and selecting the task from the one or more tasks based at least on a difficulty level of the task assessed by the at least one other user.

According to embodiments illustrated herein, there is provided a computer program product for use with a computing device. The computer program product comprises a non-transitory computer readable medium, the non-transitory computer readable medium stores a computer program code for imparting a spoken language training. The computer readable program code is executable by one or more processors in the computing device to perform a spoken language evaluation of a speech input received from a user on a first training content. The spoken language evaluation corresponds to an evaluation of the speech input with respect to a pronunciation, a prosody, an intonation, a spoken grammar, and a spoken fluency. Further, the user is categorized in a user group from one or more user groups based on the spoken language evaluation and a user profile of the user. Thereafter, a second training content is transmitted to the user based at least on the categorization and the spoken language evaluation, wherein the second training content comprises one or more tasks for the spoken language training of the user. Further, the user interacts with at least one other user who belongs to at least the user group. The interaction comprises comparing a temporal progression of the user with the at least one other user on the one or more tasks, challenging the at least one other user on a task from the one or more tasks, and selecting the task from the one or more tasks based at least on a difficulty level of the task assessed by the at least one other user.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate the scope and not to limit it in any manner, wherein like designations denote similar elements, and in which:

FIG. 1 is a block diagram of a system environment in which various embodiments can be implemented;

FIG. 2 is a block diagram that illustrates a system for imparting spoken language training to one or more users, in accordance with at least one embodiment;

FIG. 3 is a flowchart that illustrates a method for imparting spoken language training to one or more users, in accordance with at least one embodiment; and

FIGS. 4A, 4B, 4C, 4D, 4E, 4F, and 4G illustrate examples of user interfaces presented on a user's computing device for spoken language training of the user, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment”, “at least one embodiment”, “an embodiment”, “one example”, “an example”, “for example”, and so on, indicate that the embodiment(s) or example(s) may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

Definitions: The following terms shall have, for the purposes of this application, the meanings set forth below.

“Training” refers to imparting knowledge or skills pertaining to a particular domain of study such as, but not limited to, science, mathematics, art, literature, language, philosophy, and so on.

“Spoken language training” refers to a training imparted for improving spoken language skills/soft skills of a user for a particular language, e.g., English, French, German, etc. In an embodiment, the spoken language skills correspond to, but are not limited to, a pronunciation, a prosody, an intonation, a spoken grammar, and a spoken fluency.

A “user” refers to an individual who registers for the training. Hereinafter, the terms “individual”, “user”, “trainee”, “learner” have been used interchangeably.

An “expert/trainer” refers to an individual or an enterprise that contributes to the training of the users. In an embodiment, the expert/trainer may provide training content for the training of the users.

A “training content” refers to one or more tasks for improving the skills of the user. In a scenario where the training corresponds to the spoken language training, the training content may include one or more tasks for pronouncing words with sounds /d/ and /l/ to improve the user's pronunciation of such words.

A “training level” refers to a stage of proficiency achieved by an individual on the knowledge or the skills being learned during the training. In an embodiment, the training level of a user may be determined based on an evaluation of the user. Further, in an embodiment, the training level may be determined based on number/types of errors committed by the user or training goals of the user. For example, the various training levels may include a “beginner” level, an “intermediate” level, and an “advanced” level. Further, various sub-levels may exist between the two subsequent training levels. For instance, there may be one or more sub-levels between the training levels “beginner” and “intermediate”. The individual may traverse through each of the one or more sub-levels to graduate from the “beginner” level to the “intermediate” level of expertise.

“Competing” refers to an act performed by an individual for achieving a goal that has been accomplished or is being accomplished by one or more other individuals. For example, a person A completes a task in 5 minutes. Another person, person B, realizes that he/she can complete the task in less than 5 minutes. Hence, the person B may compete with the person A on the task by trying to complete the task in less than 5 minutes.

“Challenging” refers to an act performed by an individual for demanding one or more other individuals to achieve a goal that has been accomplished or is being accomplished by the individual. For example, a person A challenges a person B to complete a task in less than 10 minutes, when the person A completes the task in 10 minutes.

A “temporal progression” refers to a performance statistic of a user or multiple users that is measured across a time dimension. For example, a number of errors committed by a user on each day during a week. In an embodiment, the temporal progression may be associated with a single user or multiple users across a time dimension.

“Passive gaming” refers to a gaming paradigm in which an individual can engage in a passive or a non real-time interaction with one or more other individuals or the gaming system itself on a current gaming context (i.e., one or more tasks/objectives in the game). For example, the individual may compare his/her performance score with performance scores of the one or more other individuals on a task/objective after the individual attempts the particular task/objective.

“Active gaming” refers to a gaming paradigm in which an individual can actively engage with one or more other individuals on a current gaming context (i.e., one or more tasks/objectives in the game). For example, the individual may challenge the one or more other individuals on a time taken to complete a task/objective, an accuracy achieved on the task/objective, points/score earned on the task/objective, and so on. Thereafter, in response to this challenge, the one or more other individuals may attempt the task/objective and compete with the individual. In an embodiment, the active gaming may involve sharing of the score along with the content/task on which the individual has achieved that score.

“Social network” refers to a communication paradigm in which an individual can interact with one or more other individuals, who are known to or otherwise acquainted with the individual. In an embodiment, the social network associated with an individual may include one or more other individuals who are connected to the individual through one or more communication platforms such as, but not limited to, social networking websites (e.g., Facebook™, Twitter™, LinkedIn™, Google+™, etc.), chat/messaging applications (Google Hangouts™, Blackberry Messenger™, WhatsApp™, etc.), web-blogs, community portals, online communities, or online interest groups. In another embodiment, the individual may not be connected to the one or more other individuals through the communication platforms, e.g., Facebook™, Twitter™, or LinkedIn™. However, the individual may know or be otherwise acquainted with the one or more other individuals. For example, a user-1 may not be connected to a user-2 and a user-3 through any communication platform. However, the user-1 may be acquainted to the user-2 by virtue of working in the same organization. Further, the user-1 may know the user-3 by virtue of living in the same locality, and so on.

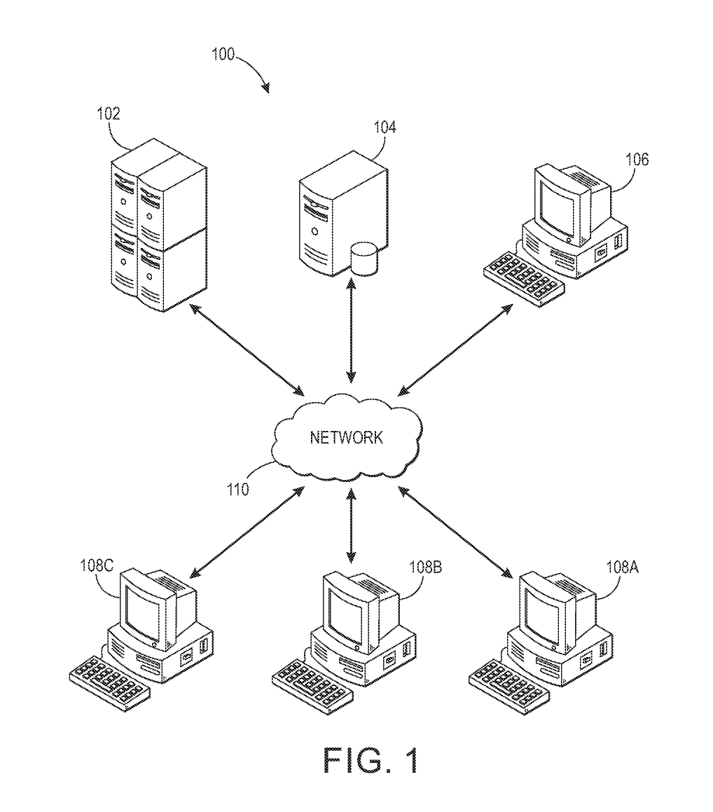

FIG. 1 is a block diagram of a system environment 100, in which various embodiments can be implemented. The system environment 100 includes an application server 102, a database server 104, a trainer-computing device 106, a plurality of user-computing devices (such as 108a, 108b, and 108c), and a network 110.

In an embodiment, the application server 102 is configured to impart a spoken language training to one or more users. In an embodiment, the application server 102 may host a web-based application for imparting the spoken language training to the one or more users. In an embodiment, the one or more users may access the web-based application through a user interface received from the application server 102. Further, in an embodiment, the one or more users may register for the spoken language training through the user-interface. In an embodiment, a user profile of the user may be generated based at least on the registration of the user. Further, based on the user profile of the user, the application server 102 may transmit a first training content to the user, which may be presented to the user on the user-computing device (e.g., 108a) through the user interface.

In an embodiment, the first training content includes one or more tasks to be performed by the one or more users. In an embodiment, the one or more users may perform the one or more tasks by providing a speech input corresponding to the one or more tasks. In an embodiment, the application server 102 may evaluate the speech input received for the one or more tasks in the first training content. In an embodiment, the spoken language evaluation corresponds to an evaluation of the speech input with respect to a pronunciation, a prosody, an intonation, a spoken grammar, and a spoken fluency. Further, in an embodiment, the spoken language evaluation may include analyzing the speech input using one or more speech processing techniques such as, but not limited to, a force-aligned automatic speech recognition, a syllable-level speech analysis, a pitch contour analysis, and a signal processing. Thereafter, based on the evaluation of the one or more users and a user profile associated with each of the one or more users, the application server 102 may categorize the one or more users in one or more user groups. Further, the application server 102 may transmit a second training content, containing another set of one or more tasks, to the one or more users based at least on the categorization and the spoken language evaluation. In an embodiment, the second training content is presented to the one or more users through the user interface.

In an embodiment, the application server 102 may be realized through various web-based technologies such as, but not limited to, a Java web-framework, a .NET framework, a PHP framework, or any other web-application framework.

In an embodiment, the database server 104 is configured to store a repository of training contents and the user profiles of the one or more users. In an embodiment, the database server 104 may receive a query from the application server 102 and/or the trainer-computing device 106 to extract/store a training content from/to the repository of training contents stored on the database server 104. In addition, the database server 104 may receive a query from at least one of the application server 102, the trainer-computing device 106, or the user-computing device (e.g., 108a) to extract/update the user profile of the user stored on the database server 104.

In an embodiment, the database server 104 may be realized through various technologies such as, but not limited to, Microsoft® SQL Server, Oracle™, and My SQL™. In an embodiment, the application server 102, the trainer-computing device 106, and the user-computing device (e.g., 108a) may connect to the database server 104 using one or more protocols such as, but not limited to, Open Database Connectivity (ODBC) protocol and Java Database Connectivity (JDBC) protocol.

A person with ordinary skill in the art would understand that the scope of the disclosure is not limited to the database server 104 as a separate entity. In an embodiment, the functionalities of the database server 104 can be integrated into the application server 102 and/or the trainer-computing device 106.

In an embodiment, the trainer-computing device 106 may correspond to a computing device used by a trainer/expert to upload a training content to the database server 104. The uploaded training content may then be stored within the repository of training contents in the database server 104. In an embodiment, the trainer/expert may receive a performance report associated with the spoken language evaluation of the user (or the one or more users) from the application server 102. Thereafter, based on the received performance report, the trainer/expert may recommend the second training content from the repository of training contents for the user (or the one or more users). Alternatively, the trainer/expert may upload a fresh training content to the database server 104 based on the received performance report.

As discussed above, the application server 102 may categorize the one or more users in the one or more users groups. In alternate embodiment, the trainer-computing device 106 may transmit the second training content to the users in a particular user group.

In an embodiment, the trainer-computing device 106 may be realized as one or more computing devices including, but not limited to, a personal computer, a laptop, a personal digital assistant (PDA), a mobile device, a tablet, or any other computing device.

A person with ordinary skill in the art would understand that the scope of the disclosure is not limited to the application server 102 and the trainer-computing device 106 as separate entities. In an embodiment, the functionalities of the application server 102 may be implemented on the trainer-computing device 106.

In an embodiment, the user-computing device (such as 108a, 108b, and 108c) may correspond to a computing device used by the user to access the web-based application through the user interface received from the application server 102. In an embodiment, the user may register for the spoken language training through the user interface. Thereafter, the user may be presented with a training content (such as the first training content, the second training content, etc.) through the user interface received from the application server 102. In an embodiment, the training content (such as the first training content, the second training content, etc.) may include one or more tasks for the spoken language training of the user. In an embodiment, the user may attempt the one or more tasks by providing a speech input for the one or more tasks. In an embodiment, the user-computing device (e.g., 108a) may include a speech-input device to receive such speech input from the user. In another embodiment, the speech-input device may not be a part of the user-computing device (e.g., 108a). In this case, the speech-input device may be communicatively coupled to the user-computing device (e.g., 108a). Examples of the speech input device include, but are not limited to, a carbon microphone, a fiber optic microphone, a dynamic microphone, an Electret microphone, a crystal microphone, a condenser microphone, or any other acoustic-to-electric transducer.

In an embodiment, the user-computing device (e.g., 108a) may submit the speech input received from the user to the application server 102 for the spoken language evaluation. In an alternate embodiment, the user-computing device (e.g., 108a) may perform the spoken language evaluation of the user based on the received speech input. Thereafter, the user-computing device (e.g., 108a) may send a result of the spoken language evaluation performed by the user-computing device (i.e., 108a) to the application server 102.

Further, in an embodiment, while performing the one or more tasks, the user may interact with at least one other user through the user interface. In an embodiment, the at least one other user may belong to at least the user group of the user. In an embodiment, the at least one other user may also belong to a social networking group of the user. In an embodiment, the social networking group of the user may include the user's connections on one or more online communication platforms such as, but not limited to, social networking websites (e.g., Facebook™, Twitter™, LinkedIn™, Google+™, etc.), chat/messaging applications (Google Hangouts™, Blackberry Messenger™, WhatsApp™, etc.), web-blogs, community portals, online communities, or online interest groups. In another embodiment, the individual may not be connected to the one or more other individuals through the online communication platforms, e.g., Facebook™, Twitter™, or LinkedIn™. However, the individual may know or be otherwise acquainted with the one or more other individuals. For example, a user-1 may not be connected to a user-2 and a user-3 through an online communication platform. However, the user-1 may be acquainted to the user-2 by virtue of working in the same organization. Further, the user-1 may know the user-3 by virtue of living in the same locality, and so on. In an embodiment, the users may connect with each other through the user interface. Thus, a user may add another user into his/her social network through the user interface. In an embodiment, the interaction may comprise, but is not limited to, the user comparing a temporal progression of the user with the at least one other user on the one or more tasks, the user challenging the at least one other user on a task from the one or more tasks, the user selecting the task from the one or more tasks based on a difficulty level of the task assessed by the at least one other user, and the user competing with the at least one other user on at least one of a performance score or a time taken, on the task. Further, in an embodiment, the user may engage in an active gaming or a passive gaming interaction with the at least one other user on the task. In an embodiment, the user-computing devices 108a, 108b, and 108c may communicate with each other over the network 110 to enable the interaction between the one or more users.

In an embodiment, the user-computing device (such as 108a, 108b, and 108c) may be realized as one or more computing devices including, but not limited to, a personal computer, a laptop, a personal digital assistant (PDA), a mobile device, a tablet, or any other computing device.

The network 110 corresponds to a medium through which content and messages flow between various devices of the system environment 100 (e.g., the application server 102, the database server 104, the trainer-computing device 106, and the plurality of user-computing devices (such as 108a, 108b, and 108c)). Examples of the network 110 may include, but are not limited to, a Wireless Fidelity (Wi-Fi) network, a Wireless Area Network (WAN), a Local Area Network (LAN), or a Metropolitan Area Network (MAN). Various devices in the system environment 100 can connect to the network 110 in accordance with various wired and wireless communication protocols such as Transmission Control Protocol and Internet Protocol (TCP/lP), User Datagram Protocol (UDP), and 2G, 3G, or 4G communication protocols.

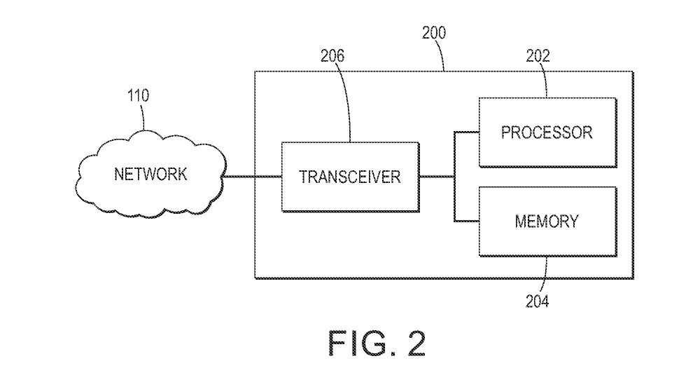

FIG. 2 is a block diagram that illustrates a system 200 for imparting the spoken language training to the one or more users, in accordance with at least one embodiment. In an embodiment, the system 200 may correspond to the application server 102 or the trainer-computing device 106. For the purpose of ongoing description, the system 200 is considered as the application server 102. However, the scope of the disclosure should not be limited to the system 200 as the application server 102. The system 200 can also be realized as the trainer-computing device 106.

The system 200 includes a processor 202, a memory 204, and a transceiver 206. The processor 202 is coupled to the memory 204 and the transceiver 206. The transceiver 206 is connected to the network 110.

The processor 202 includes suitable logic, circuitry, and/or interfaces that are operable to execute one or more instructions stored in the memory 204 to perform predetermined operations. The processor 202 may be implemented using one or more processor technologies known in the art. Examples of the processor 202 include, but are not limited to, an x86 processor, an ARM processor, a Reduced Instruction Set Computing (RISC) processor, an Application-Specific Integrated Circuit (ASIC) processor, a Complex Instruction Set Computing (CISC) processor, or any other processor.

The memory 204 stores a set of instructions and data. Some of the commonly known memory implementations include, but are not limited to, a random access memory (RAM), a read only memory (ROM), a hard disk drive (HDD), and a secure digital (SD) card. Further, the memory 204 includes the one or more instructions that are executable by the processor 202 to perform specific operations. It is apparent to a person with ordinary skills in the art that the one or more instructions stored in the memory 204 enable the hardware of the system 200 to perform the predetermined operations.

The transceiver 206 transmits and receives messages and data to/from various components of the system environment 100 (e.g., the database server 104, the trainer-computing device 106, and the plurality of user-computing devices (such as 108a, 108b, and 108c)) over the network 110. Examples of the transceiver 206 may include, but are not limited to, an antenna, an Ethernet port, a USB port, or any other port that can be configured to receive and transmit data. The transceiver 206 transmits and receives data/messages in accordance with the various communication protocols, such as, TCP/lP, UDP, and 2G, 3G, or 4G communication protocols.

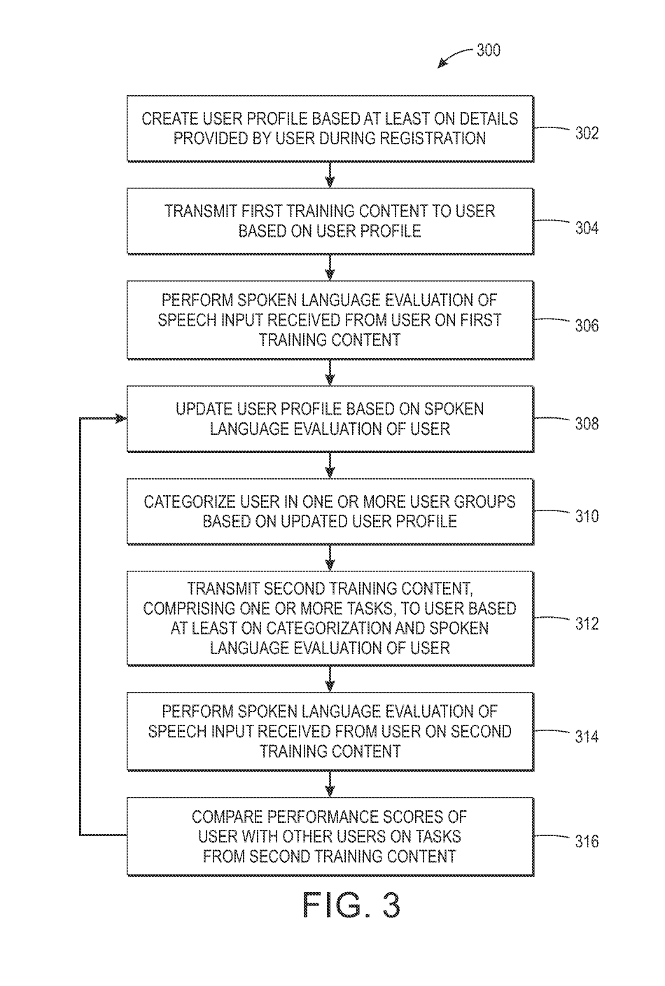

The operation of the system 200 for imparting the spoken language training to the one or more users has been described in conjunction with FIG. 3.

FIG. 3 is a flowchart 300 illustrating a method for imparting the spoken language training to the one or more users, in accordance with at least one embodiment. The flowchart 300 is described in conjunction with FIG. 1 and FIG. 2.

At step 302, the user profile is created based at least on details provided by the user during the registration. In an embodiment, the processor 202 is configured to create the profile of the user. In an embodiment, the user may register with the web-application through the user interface for the spoken language training. While the registration, the user may provide various details such as, but not limited to, an age of the user, a gender of the user, a mother tongue/dialect of the user, a region to which the user belongs, a nationality of the user, an educational background of the user, a professional background of the user, and training goals of the user. In an embodiment, the user profile may be created based on the various details provided by the user during the registration. The following table illustrates an example of the user profile:

TABLE 1
An example of user profile

| Data Field in User Profile | Values |
|---|---|
| Name | “ABC” |
| Age | 35 years |
| Gender | Male |
| Mother Tongue/Dialect | French |
| Nationality | France |
| Region | Lyon |
| Educational Qualifications | Graduate |
| Profession | Merchant |
| Training Goals | Improving spoken fluency, diction, |
| | and oratory skills in English |

In an embodiment, during the registration, the user may be presented with one or more sample tasks through the user interface. The one or more sample tasks may include one or more words/phrases/sentences. The user may be required to pronounce the one or more words/phrases/sentences by providing a speech input. Based on such speech input provided by the user, the processor 202 may ascertain the mother tongue/dialect of the user. Further, the processor 202 may also identify one or more pronunciation errors of the user based on the speech input received from the user on the one or more sample tasks. Thereafter, in an embodiment, the processor 202 may update the user profile based on the determined mother tongue/dialect and the identified one or more pronunciation errors of the user.

In addition, in an embodiment, the user profile may also include information related to the spoken language evaluation of the user such as, but not limited to, a performance score of the user on the one or more tasks, types of spoken language errors committed by the user, a learning curve associated with the user, and so on. In an embodiment, the processor 202 may update the user profile of the user with the information related to the spoken language evaluation and/or the training goals of the user, as explained further with reference to step 308.

At step 304, the first training content is transmitted to the user. In an embodiment, the processor 202 is configured to transmit the first training content to the user. The user may access the first training content through the user interface on the user-computing device (e.g., 108a). In an embodiment, the first training content may be generated/determined based on the user profile of the user. For instance, based on the user profile, the processor 202 may select the first training content from the repository of training contents stored in the database server 104. Alternatively, a fresh training content may be provided by the trainer/expert based on the user profile. Thereafter, the processor 202 may transmit the fresh training content to the user as the first training content. In addition, the fresh training content may also be stored in the repository of training contents within the database server 104.

In an embodiment, the repository of the training contents in the database server 104 may be indexed based on the user profiles. The following table illustrates an example of indexing of the repository of training contents based on one or more characteristics of the users determined from the respective user profiles:

TABLE 2
An example of indexing of the repository of
training contents based on the user-profiles

| Characteristic of users | Users | Relevant training content |
|---|---|---|
| Mother tongue = | User-1, User-3 | T1: Words containing /l/ |
| “Japanese” | | and /r/ sounds |
| Mother tongue = | User-2, User-4 | T2: Tasks for word order- |
| “Mandarin” | | ing and sentence formation |
| Pronunciation errors | User-5, User-6, | T3: Words containing /s/ |
| on words with /s/ | User-7 | and /sh/ sounds |
| and /sh/ sounds | | |

Referring to the above table, the mother tongue of user-1 and user-3 is Japanese, while that of user-2 and user-4 is Mandarin. English speakers with Japanese mother tongue may find difficulties in distinguishing between /l/ and /r/ sounds. Hence, training content relevant for users of Japanese mother tongue may include words containing /l/ and /r/ sounds (i.e., training content T1). Further, English speakers with Mandarin mother tongue may commit grammatical mistakes such as incorrect word order, incorrect sentence formation, etc. Therefore, training content containing tasks for word ordering and sentence formation (i.e., training content T2) may be relevant for users with Mandarin mother tongue. A person skilled in the art would appreciate that within the repository of training contents, the training content T1 may be indexed to the user profiles of user-1 and user-3, while the training content T2 may be indexed to the user profiles of user-2 and user-4.

Further, it is evident from Table 2 that user-5, user-6, and user-7 commit pronunciation errors on words with /s/ and /sh/ sounds. Words containing /s/ and /sh sounds (i.e., training content T3) may be relevant for such users. Hence, within the repository of training contents, training content T3 may be indexed to the user profiles of user-5, user-6, and user-7.

In an embodiment, the processor 202 may select the first training content from the repository of training contents based on the user profile of the user. In the above example, the processor 202 may select the training content T3 (as the first training content) for the user-5 based on the indexing of the repository of training contents based on the user profiles. Similarly, the processor 202 may select the training content T2 (as the first training content) for the user-2, and so on.

Post the transmission of the first training content to the user, the first training content, including the one or more tasks, may be presented to the user through the user interface on the user-computing device (e.g., 108a). Thereafter, the user may attempt the one or more tasks by providing a speech input through the speech-input device of the user-computing device (i.e., 108a).

At step 306, the spoken language evaluation of the user is performed based on the speech input received from the user on the first training content. In an embodiment, the processor 202 is configured to perform the spoken language evaluation of the user based on the received speech input. In an embodiment, the spoken language evaluation corresponds to an evaluation of the speech input with respect to a pronunciation, a prosody, an intonation, a spoken grammar, and a spoken fluency. Further, in an embodiment, the processor 202 may perform such spoken language evaluation of the speech input by utilizing one or more speech analysis techniques such as, but not limited to, a force-aligned automatic speech recognition, a syllable-level speech analysis, a pitch contour analysis, and a signal processing.

Prior to evaluating the speech input, the processor 202 may initially normalize the speech input received from the user using various signal processing techniques such as, but not limited to, an amplitude based filtering, a sampling-rate based normalization, a de-emphasis filtering, and so on. Normalizing the speech input may remove distortions and noise from the speech signal corresponding to the speech input. Thereafter, the processor 202 may analyze the normalized speech input by using one or more data-driven automatic speech recognition (ASR) techniques, one or more signal processing based speech analysis techniques, or a combination thereof.

In an embodiment, the processor 202 may utilize an ASR system to force align the speech input received from the user with an expected text. For example, a task within the first training content may require the user to speak out a word “refrigerator”. The processor 202 may force align (using the ASR system) the speech input received from the user on this task with respect to the expected text (i.e., the word “refrigerator”). Thereafter, the processor 202 may associate a confidence score on each of the phones and the syllables in the expected text (i.e., “re•frig•er•a•tor” pronounced as “/ri'frij [symbol] , rāter/”) based on the speech input. A low confidence score on a particular phone or syllable may be indicative of an erroneous pronunciation of that phone or syllable by the user.

In addition, in an embodiment, the processor 202 may perform a differential analysis of acoustic characteristics of the expected phone/syllable and the actual phone/syllable (in the speech input received from the user). In an embodiment, the processor 202 may identify one or more pronunciation error patterns of the user based on such analysis. For example, the acoustic characteristics of the phone /s/ (in words such as “seen”) may include a turbulent noise-like signal in a frequency region of 4 kHz and above. Further, the acoustic characteristics of the phone /sh/ (in words such as “sheep”) may include a turbulent noise-like signal in a frequency region of 2 kHz and above. Hence, by analyzing the acoustic characteristics of the speech signal corresponding to the speech input, the processor 202 may identify whether a particular phone within the speech input corresponds to /s/ or /sh/. Thereafter, the processor 202 may compare the identified phone (e.g., the phone /s/) from the speech input with the corresponding expected phone (e.g., the phone /sh/) to determine if the user has committed a pronunciation error. Hence, based on the differential analysis, the processor 202 may identify one or more pairs of phones that the user errs on. A person skilled in the art would appreciate that the one or more pronunciation error patterns of the user may be associated with the mother tongue of the user. Hence, for a user of a particular mother tongue, the processor 202 may analyze the speech input received from the user for the one or more pronunciation error patterns associated with the particular mother tongue. However, based on the differential analysis, the processor 202 may also identify other pronunciation errors of the user, which may not be as such associated with the mother tongue of the user.

In addition to identifying the one or more pronunciation errors, in an embodiment, the processor 202 may analyze the speech input for other dimensions of the spoken language such intonation, prosody, spoken grammar, and spoken fluency. For example, the processor 202 may analyze the speech signal to determine a pitch contour (frequency spectrum of speech signal) and a syllable rate (number of syllables per unit time). The processor 202 may also determine a rate of speech (number of words per unit time) from the speech signal. A person skilled in the art would appreciate that the pitch contour and the syllable rate may be indicative of the prosodic skills of the user. Further, the spoken fluency of the user may be determined based on the rate of speech of the user. For instance, the processor 202 may determine the spoken fluency based on a ratio of a silence/near-silence time interval in the speech input and the number of words spoken per unit time (i.e., the rate of speech).

A person skilled in the art would understand that the scope of the disclosure is not limited to the evaluation of the speech input by utilizing the one or more ASR techniques, the one or more signal processing techniques, or a combination of such techniques. In an embodiment, one or more off-the-shelf speech/signal analysis software/hardware may be used for the evaluation of the speech input.

At step 308, the user profile of the user is updated based on the spoken language evaluation of the user. In an embodiment, the processor 202 is configured to update the user profile of the user. To update the user profile, in an embodiment, the processor 202 may update the information pertaining to the spoken language evaluation and/or the training goals of the user, within the user profile. As discussed with reference to step 302, the information pertaining to the spoken language evaluation may include, but is not limited to, the performance score of the user on the one or more tasks, the types of spoken language errors committed by the user, the learning curve associated with the user.

### Performance Score of the User on Tasks

For example, the processor 202 may determine the performance score of the user on the one or more tasks (included in the first training content) as a ratio of number of correctly attempted tasks to the total number of the one or more tasks (within the first training content). The processor 202 may determine a particular task as correctly attempted if the speech input provided by the user on the particular task matches an expected input for that task. For example, if the task corresponds to pronouncing a particular word (say, “refrigerator”), the processor 202 may determine the task to be correctly attempted when the user correctly pronounces that particular word (i.e., “refrigerator”).

A person skilled in the art would appreciate that the performance score of the user on the one or more tasks may be determined in a variety of other ways without departing from the scope of the disclosure. For instance, in an embodiment, the performance score of the user on a task may be determined based on a time taken by the user on the task. Further, in an embodiment, the performance score may be determined based on a type of the task, a number/type of errors committed by the user on the task, a training level associated with the user, or a measure of performance of the user with respect to the other users on the task.

### Types of Pronunciation Errors Committed by the User

As discussed with reference to step 306, the processor 202 may identify one or more pronunciation errors of the user. In an embodiment, the processor 202 may determine the types of spoken language errors committed by the user by analyzing the identified one or more pronunciation errors of the user. For example, the processor 202 identifies that the user wrongly pronounces words containing the phone /s/. Accordingly, the processor 202 may determine the type of spoken language error as wrong pronunciation of the phone “/s/”.

### Learning Curve of the User

In an embodiment, the processor 202 may determine the learning curve of the user based at least on a number of the one or more tasks attempted by the user and a number of pronunciation errors committed by the user. Further, the learning curve may also be determined based on a time taken by the user to attempt the one or more tasks.

### Training Goals of the User

In an embodiment, the training goals of the user may correspond to one or more learning objectives of the user for the spoken language training. The one or more learning objectives may include improvement of various aspects of the spoken language skills of the user such as, but not limited to, vocabulary, pronunciation, spoken grammar, spoken fluency, intonation, prosody, and so on. In an embodiment, the user may provide the training goals during the registration. For example, the user may provide a training goal of improving pronunciation of words containing the sounds “/fri/”, “/sh/”, and so on. Further, in an embodiment, based on the spoken language evaluation of the user, the processor 202 may ascertain the training goals of the user, in addition to those provided by the user during the registration. For example, the processor 202 may identify that the user wrongly pronounces words containing the sound “/d/”. Thus, the processor 202 may add a training goal of improving pronunciation of words containing the sound “/d/” for the user.

Thus, the processor 202 may update the user profile based on the information pertaining to the spoken language evaluation of the user and/or the additional training goals of the user. Further, in an embodiment, the processor 202 may transmit a notification to the user through the user interface indicating the updation of the user profile of the user.

For example, considering a case study of the user “ABC” with the user profile as illustrated in Table 1. The first training content transmitted to the user “ABC” includes 20 tasks for reading aloud given sentences. He correctly attempts 17 tasks and commits errors on the remaining 3 tasks. Hence, the processor 202 may determine the performance score of the user “ABC” as 0.85 or 85% (i.e., 17/20). Further, based on the number of errors committed on each task, the processor 202 may determine the learning curve of the user “ABC”. For instance, if the user “ABC” commits 7 errors on the first task, 5 errors on the second task, 3 errors on the third task, and no error thereafter, the learning curve of the user “ABC” is steep, which may reflect that the user “ABC” has learned quickly. Similar learning curve may be determined by the processor 202 based on the time taken by the user “ABC” on each task.

Further, based on the spoken language evaluation of the user “ABC” on the 20 tasks within the first training content, the processor 202 may determine that the user “ABC” commits mistakes (or is prone to commit mistakes) on words containing /fri/ and /d/ sounds. Accordingly, the processor 202 may add an additional training goal of improving pronunciation of words containing /fri/ and /d/ sounds to the user profile of the user “ABC”.

At step 310, the user is categorized in the one or more user groups based on the updated user profile of the user. In an embodiment, the processor 202 is configured to categorize the user in one of the one or more user groups. In an embodiment, each of the one or more user groups includes users with similar user profiles. Thus, the processor 202 may categorize each of the one or more users in a user group based on the updated user profile (as discussed in step 308) of the respective user. For example, users who commit similar types of spoken language errors and/or users with similar training goals may be categorized in the same user group. Further, users with the same mother tongue/dialect and/or same nationality may be categorized in the same user group. A person skilled in the art would appreciate that each user may be simultaneously categorized in more than one user group. For example, a user may be categorized in a user group-1 based on the spoken language errors committed by the user. Further, the user may be categorized in a user-group-2 based on the mother tongue/dialect of the user.

A person having ordinary skills in the art would understand that the one or more users may be categorized in the one or more user groups based on the user profile created in the step 302. The first training content may be transmitted to the one or more users based on the categorization.

At step 312, the second training content is transmitted to the user. In an embodiment, the processor 202 is configured to transmit the second training content to the user. In an embodiment, the second training content may be based on the user group of the user (i.e., the categorization of the user in the one or more user groups). In addition, in an embodiment, the second training content may be based on the spoken language evaluation of the user (as described in step 306). A person skilled in the art would appreciate that the second training content transmitted to a user may include a generic training content relevant for the user group of the user and a specific training content corresponding to the spoken language evaluation of the user. Thus, the specific training content may cater to user-specific training needs which may or may not be the same as common training needs of a majority of users belonging to the user group. In an embodiment, the generic training content may be determined based on the user group, the training level, and the training goals of the user. Further, in an embodiment, the specific training content may determined based on a training sub-level associated with the user.

For example, various training-levels may include a “beginner” level, an “intermediate” level, and an “advanced” level. The training level of the user may be determined based at least on the user group and the training goals of the user. For instance, the user at the “beginner” level may have a training goal of improving his/her pronunciation. Further, the user at the “intermediate” level may have a training goal of improving his/her grammar, while the user at the “advanced” level may have a training goal of improving his/her fluency and diction skills.

Further, various sub-levels may exist between each subsequent training levels. For instance, one or more sub-levels may exist between the training levels “beginner” and “intermediate”. Similarly, one or more sub-levels may exist between the training levels “intermediate” and “advanced”. The users may have to traverse through each of the one or more sub-levels in order to reach a higher training level. In an embodiment, the processor 202 may assign a sub-level to the user based on the spoken language evaluation of the user. Accordingly, the second training content transmitted to the user may in-turn depend on the current sub-level of the user. For example, a user-1 who commits very frequent mistakes on the /s/ and /sh/ sounds may be assigned a sub-level 1 (within the “beginner” level), while a user-2 who commits occasional mistakes on the /l/ and /r/ sounds may be assigned a sub-level 2 (within the “beginner” level), and so on. Accordingly, the second training content transmitted to the user-1 may include simple and short words containing the /s/ and /sh/ sounds such as “see”, “sun”, “sheep”, “shy”, “shun”, etc.; while the second training content transmitted to the user-2 may include complex and longer words containing the /l/ and /r/ sounds such as “labyrinth”, “laryngitis”, “larvae”, “lasagna”, and so on.

A person having ordinary skill in the art would appreciate that the categorization of the one or more users may be performed by the processor 202 on each sub-level. For example, the users on the sub-level-1 may be categorized in a single user group. Similarly, the user on the sub-level-2 may be categorized in another user group.

In an embodiment, the processor 202 may upgrade the sub-level of the user based on one or more incremental improvements of the spoken language skills of the user, which may be determined based on the spoken language evaluation of the user. Further, in an embodiment, the second training content transmitted to the user may be tailored to cater to the upgraded sub-level of the user. Considering the above example, the user-1 previously made frequent mistakes (say 20 mistakes on 40 words) while pronouncing words with the sounds /s/ and /sh/. However, based on a current spoken language evaluation of the user, the processor 202 determines that the frequency of such mistakes has reduced below a predetermined threshold; say 2 or less mistakes on 40 words. Accordingly, the processor 202 may upgrade the sub-level of user-1 from the sub-level-1 to the sub-level 2, considering that the user-1 also commits errors on the /l/ and /r/ sounds. The second training content transmitted to the user after such sub-level up-gradation may include a training content relevant to the upgraded sub-level of the user. For instance, in the above example, the user-1 may be transmitted words containing the /l/ and /r/ sounds.

In an embodiment, the processor 202 may perform a skip sub-level up-gradation for the user if the user has already achieved the spoken language skills that are associated with the skipped sub-level. In the above example, the user-1 may be directly promoted to a sub-level-3 if the user has already improved his/her pronunciation of words containing the /l/ and /r/ sounds. Accordingly, the second training content transmitted to the user may be relevant to the current sub-level of the user, i.e., the sub-level succeeding the skipped sub-level.

In an embodiment, the processor 202 may create a new sub-level between two subsequent training levels based on the spoken language evaluation of the user. For example, a user at the beginner level commit error while pronouncing words with sounds /d/ and /t/. Accordingly, the processor 202 may create a sub-level corresponding to such mistakes.

In an embodiment, the expert/trainer may suggest a training content (from the repository of training contents) for the users belonging to each of the one or more user groups. In another embodiment, the expert/trainer may upload a fresh training content (which is not already included in the repository of training contents) to the database server 104 for each of the one or more user groups. Thereafter, the database server 104 may store the uploaded fresh training content in the repository of training contents. In an embodiment, the processor 202 may transmit the training content suggested/uploaded by the expert/trainer (i.e., the training content suggested by the expert/trainer from the repository of training contents or the fresh training content uploaded by the expert/trainer) for the user group of the user as the second training content to the user.

In an embodiment, the processor 202 may select the second training content from the repository of training contents stored in the database server 104 based on the user group of the user. For example, for a group of users with the Japanese mother tongue, the processor 202 may select a training content containing words with /l/ and /r/sounds for pronunciation by such users. In addition, in an embodiment, the processor 202 may select the second training content from the repository of training contents based on the spoken language evaluation of the user. For example, based on the spoken language evaluation of a user (as described in step 306), the processor 202 determines that the user commits frequent pronunciation errors on words containing the syllable “/fri/”. Hence, the processor 202 may select a training content containing words such as “free”, “freak”, “frisk”, “infringe”, and so on for pronunciation by the user.

A person skilled in the art would understand that the scope of the disclosure is not limited to the transmitting the second training content, as discussed above. In an embodiment, the second training content transmitted to the user may include the training content suggested/uploaded by the expert/trainer, in addition to the training content selected by the processor 202 from the repository of training contents. Further, as discussed above, as a user may be categorized in more than one group. Accordingly, the second training content transmitted to the user may include training content relevant to each user-group to which the user belongs.

Post transmission of the second training content to the user, the second training content is presented to the user on the user-computing device (e.g., 108a) through the user interface. In an embodiment, the second training content may include one or more tasks for the spoken language training of the user. For example, the one or more tasks within the second training content may include one or more words for pronunciation, one or more phrases for sentence re-ordering/formation, one or more sentences/paragraphs for oration, etc. In an embodiment, while the user attempts the one or more tasks within the second training content, the user may interact with other users through the user interface, as explained further.

In an embodiment, while attempting the one or more tasks, the user may interact with the other users through the user interface. In an embodiment, the other users may include at least one user belonging to the user group of the user. In addition, in an embodiment, the other users may also include at least one user belonging to a social network group of the user. In an embodiment, the social networking group of the user may include the user's connections on one or more online communication platforms such as, but not limited to, social networking websites (e.g., Facebook™, Twitter™, LinkedIn™, Google+™, etc.), chat/messaging applications (Google Hangouts™, Blackberry Messenger™, WhatsApp™, etc.), web-blogs, community portals, online communities, or online interest groups. In another embodiment, the individual may not be connected to the one or more other individuals through the online communication platforms, e.g., Facebook™, Twitter™, or LinkedIn™. However, the individual may know or be otherwise acquainted with the one or more other individuals. For example, a user-1 may not be connected to a user-2 and a user-3 through an online communication platform. However, the user-1 may be acquainted to the user-2 by virtue of working in the same organization. Further, the user-1 may know the user-3 by virtue of living in the same locality, and so on. In an embodiment, the users may connect with each other through the user interface. Thus, a user may add another user into his/her social network through the user interface. In an embodiment, the user interaction may include, but is not limited to, the user comparing a temporal progression of the user with the other users on the one or more tasks, the user challenging the other users on a task from the one or more tasks, the user selecting the task from the one or more tasks based on a difficulty level of the task assessed by the other users, and the user competing with the other users on at least one of a performance score or a time taken, on the task. Further, in an embodiment, the user may engage in an active gaming or a passive gaming interaction with the at least one other user on the task. The various aspects of user interaction are elucidated further with the help of examples.

Comparing a Temporal Progression with Other Users on Tasks

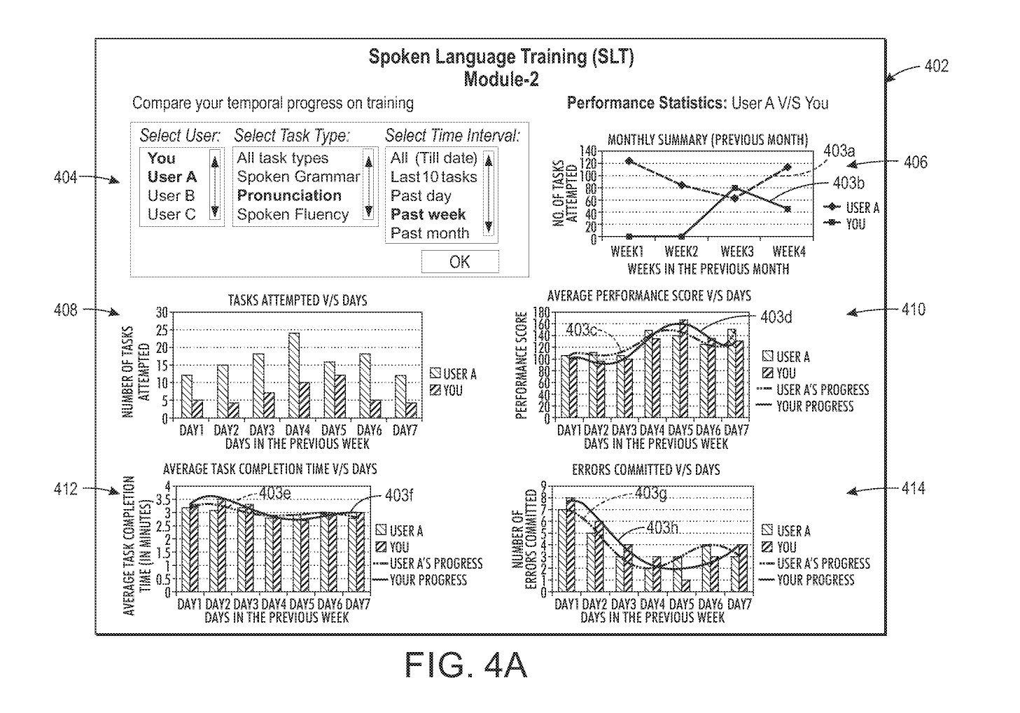

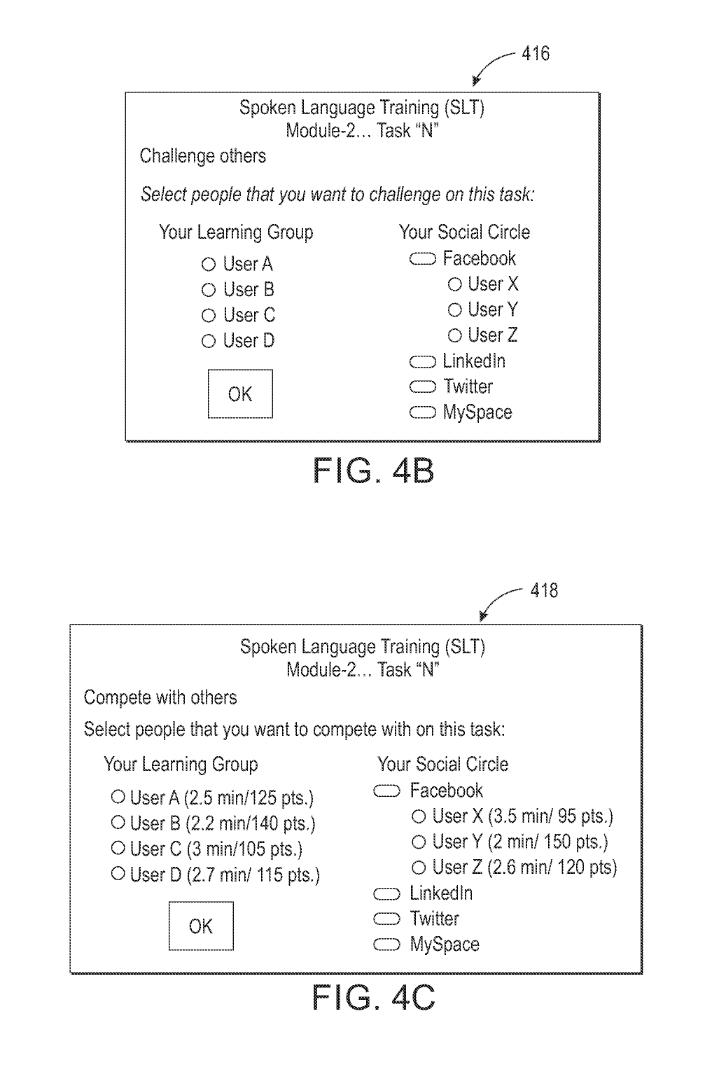

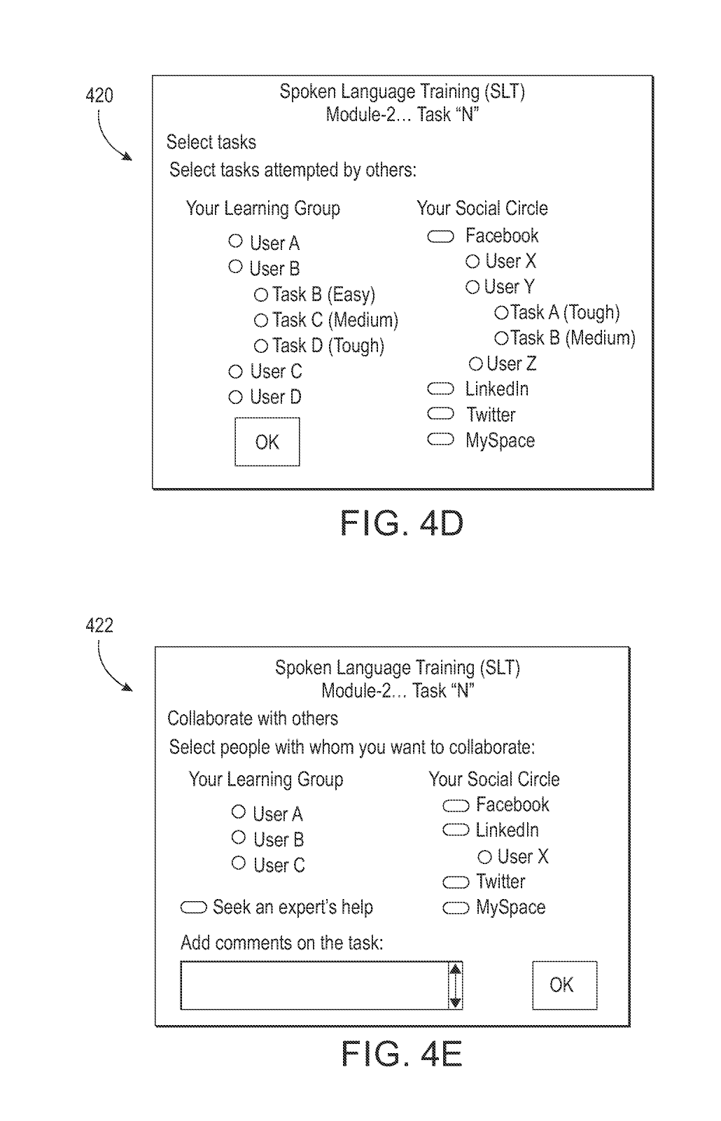

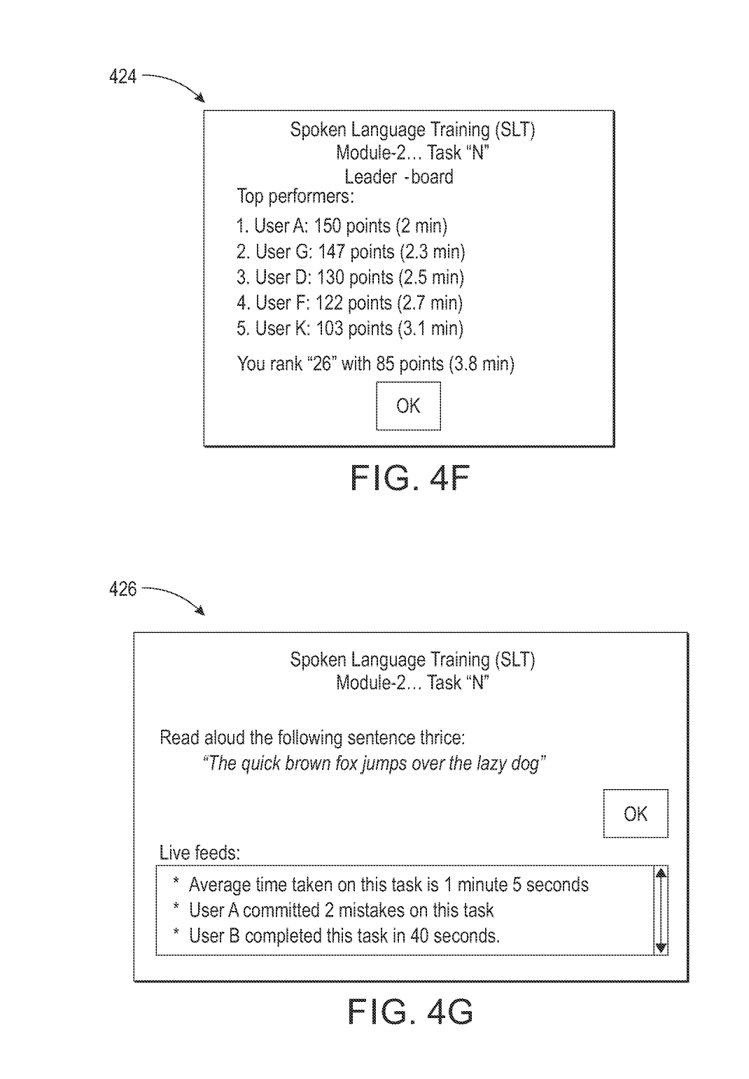

A user may wish to assess his/her progress on the spoken language training with respect to the other users within his/her user group and/or his/her social networking group. Accordingly, the user may be presented with comparative statistics corresponding to a temporal progression of the user with respect to the other users though the user interface. Such comparison of the performances of the users with respect to a time dimension may help a user assess his/her progress benchmarked against his/her peers. For example, a user-1 registers for the training one month after a user-2. After pursuing the training for one week, the user-1 may wish to compare his/her performance with that of the user-2 in the first week of the training. For instance, in the first week of the training, the user-1 committed 10 grammatical errors and 4 pronunciation errors, while the user-2 committed 7 grammatical errors and 6 pronunciation errors. Based on such comparison, the user-1 may realize that he/she needs to catch up on his/her grammatical skills. Further, the user-1 may want to know performance statistics of the user-2 in the second, the third, and the fourth weeks of the training. The user-1 may plan his/her training in the forthcoming weeks based on the performance statistics of the user-2 in the second, the third, and the fourth weeks. In an embodiment, examples of the performance statistics include, but are not limited to, number/types of tasks attempted, number/type of errors committed, a time taken on each task, and so on. An example of a user interface through which a user may compare a temporal progression with the other users on the one or more tasks is illustrated in FIG. 4A.

In an embodiment, the user may compare his/her own performance over a period of time to assess his/her temporal progression on the training. An example user interface through which the user assess his/her temporal progression on the training over a period of time is illustrated in FIG. 4A.

### Challenging Other Users on Tasks

For example, a user-1 completes tasks A and B in the second training content, and may feel that he/she has performed well on the task A and not so well on the task B. So, the user-1 may wish to compare his/her performance on the task A and the task B with others in his/her user group and/or his/her friend circle (on social networking sites). Accordingly, the user-1 may challenge the other users (such as a user-2, a user-3, and a user-4) through the user interface. The other users (i.e., the user-2, the user-3, and the user-4) may accept the challenge and complete the task A and the task B. Thereafter, the user-1 may receive a notification containing information pertaining to the performance of these users (i.e., the user-2, the user-3, and the user-4) on the task A and the task B, compared to the performance of the user-1. An example of a user interface through which a user may challenge the other users on the task is illustrated in FIG. 4B.

The aspect of challenging the other users on a task may provide an active gamification (or gaming) experience to the user as the user can interact with the other users in a real-time with respect to the current task at hand. Such active gaming experience may provide intrinsic motivation and drive to the users, thereby reducing a chance that the user drops out from the training.

Competing with Other Users on a Performance Score or a Time Taken on a Task

For example, a user-2 and a user-3 have attempted a task C in 5 minutes and 4 minutes, respectively. Further, based on their performance on the task C, the user-2 and the user-3 are assigned performance scores of 120 points and 135 points respectively. The user-1 may feel that he/she can perform well on the task C and can complete the task C faster than both the user-2 and the user-3 (i.e., in less than 4 minutes), and also score more points than both the user-2 and the user-3 (i.e., attain a performance score greater than 135). Accordingly, through the user interface, the user-1 may choose to attempt the task C and may provide an input for comparing his/her performance score/task completion time with the user-2 and the user-3. Once the user-1 completes the task C, the performance score/task completion time of the user-1 on the task C are compared to that of the user-2 and the user-3. Further, the user-2 and the user-3 may receive a notification containing the performance score/task completion time of the user-1 with respect to the user-2 and the user-3 respectively. An example of a user interface through which a user may compete with the other users on a task is illustrated in FIG. 4C.

### Selecting Tasks Based on Difficulty Level Assessed by Other Users

Each user, such as the user-1, the user-2, the user-3, and the user-4 in the above example, may find certain tasks difficult to attempt or may want to seek clarification on some tasks from the other users or the expert/trainer. Accordingly, a user, say the user-1, may prompt the other users for attempting such tasks. Thereafter, the others users, for example, the user-2, may select one or more of such tasks, when prompted by the user-1. Further, each user may associate a difficulty level with each task that the user attempts. In an embodiment, a user may select a task based at least on a difficulty level of the task assessed by the other users belonging to the user's group and/or social networking circle. An example of a user interface through which a user may select tasks attempted by the other users is illustrated in FIG. 4D.

In an embodiment, the user may interact with the other users to collaborate on difficult tasks to learn difficult concepts. Also, solving difficult tasks collectively may motivate the users to attempt such tasks that the users may not otherwise have attempted on their own. An example of a user interface through which users may collaborate to solve difficult tasks is illustrated in FIG. 4E. Further, in an embodiment, the user may request the trainer/expert for help on a difficult task.

### Collaborative Tasks

In an embodiment, the one or more tasks may require collaboration between the users of a user group. For example, the one or more tasks for improving spoken fluency of the users may require the users to speak on a pre-determined topic, for instance, self-introduction, hobbies and interests, a recent movie, a novel, current affairs, and so on. The processor 202 may provide the user with the pre-determined topic or allow the user to choose one of the topics that the other users have spoke on. Alternatively, the user may choose a fresh topic. Further, the processor 202 may enable the users of a user group to rate/comment on a speech input provided by the other users or a speech input provided by the user himself/herself on such tasks.

In an embodiment, the user may engage in an active gaming or a passive gaming interaction with the other users on the one or more tasks through the user interface. In an embodiment, the active gaming interaction may correspond to at least a combination of the comparison of the temporal progression of the users, challenging the other users on the task, and selecting the task from the one or more tasks based on difficulty level of the task assessed by the other users. In an embodiment, the passive gaming interaction may at least correspond to competing with the other users with respect to a performance score or a time taken on the task.

Thus, the user may interact with the other users while attempting the one or more tasks in the second training content. The aspect of user interactivity may gamify the experience of the users undergoing the spoken language training. As the users can interact with one another while attempting the one or more tasks, the users may be driven to perform better on the one or more tasks. The aspects of challenging other users on tasks and comparing performance on tasks may infuse competitive spirit among the users and encourage them to outperform others. Further, the collaboration among the users while solving difficult tasks may help the users to grasp difficult concepts. Thus, the various aspects of user interactivity may provide motivation to the users and help them learn well.

Further, in an embodiment, the user may feel a game-like experience (gamification) during the training in various contexts/situations such as tasks/training content (e.g., selecting a task marked as difficult by another user), performance comparison with respect to the other users on a task (e.g., comparing a rank, a score, time, errors, etc.; on a task), and the user's specific and dynamic training needs (e.g., the user receives training content that is specific to the user's current learning progress, error patterns, training goals, training level/sub-level, the user's group, and so on). For example, when the user challenges one or more other users on a task, the user may experience an active gaming experience on the task due to an aspect of real-time user interactivity on the task. Such aspects of active gamification may entrench the users into continuing with the training and may further improve their learning curve.

Once the user attempts a task (or the entire set of the one or more tasks) by providing a speech input, the user may submit the task (or the entire set of the one or more tasks) through the user interface for evaluation. In an embodiment, the processor 202 may evaluate the spoken language skills of the user by analyzing the speech input received from the user on the second training content, as explained further.

At step 314, the spoken language evaluation of the user is performed based on the speech input received from the user on the second training content. In an embodiment, the processor 202 is configured to perform the spoken language evaluation of the speech input received from the user on the second training content. In an embodiment, the processor 202 may perform the spoken language evaluation of the received speech input in a manner similar to that described in step 306.

In an embodiment, based on the spoken language evaluation of the other users belonging to the user group of the user, the processor 202 may provide the user with real-time information related to a task that the user is currently attempting. In an embodiment, the real-time information may include comparative statistics corresponding to the temporal progression (as described in step 312) of the user with respect to the other users on the one or more tasks. Accordingly, the processor 202 may monitor the performance of the users within each user-group on a real-time basis (based on the spoken language evaluation of the users on each task) and provide comparative statistics to each user while the user attempts a task. For example, while a user attempts a task through the user interface, the processor 202 may provide the user with comparative statistics of the performance of the other users (belonging to the user-group or the social friend circle of the user) on the same task. Examples of such comparative statistics include, but are not limited to, top scorers on the task, average score of the users on the task, average time taken by users on the task, common mistakes committed by the users on the tasks, and so on. Further, in an embodiment, the real-time information may include a leader-board and live feeds, which are displayed to the user along with the task that the user is currently attempting through the user interface. The leader-board may provide a comparative ranking of the users with respect to their performance scores on that task in the second training content. For e.g., the users may be assigned points based on the number and/or the type of errors committed, average time taken per task, and so on. The leader-board may enlist the top five users on that task based on the points. Further, each user may be provided a comparative rank on the leader-board based on the points assigned to the user. In addition, the live feeds may notify a user about the performance of other users on specific tasks as compared to the performance of the user on such tasks. Such leader-boards and live feeds may further provide intrinsic motivation to the user for attempting the one or more tasks. Example of the user interface including the leader-board and the live feeds are illustrated in FIG. 4F and FIG. 4G, respectively.

Further, in an embodiment, the processor 202 may aggregate the comparative statistics over a period of time (which may be pre-determined or specified by the user), say, a week, a fortnight, a month, and so on, and provide each user with a comparative performance report after such time period. For example, the processor 202 may provide a performance report on a weekly basis with statistics such as a number and a type of mistakes committed by the user vis-à-vis the other users during the week. Such performance reports may help the users to analyze a temporal progression of their learning with respect to the other users. The following table illustrates an example of a performance report sent to the user “ABC”:

TABLE 3
An example of performance report sent to the user “ABC”

| Fields of the performance report | Values |
|---|---|
| No. of tasks attempted | 20 |
| No. of tasks correctly attempted | 17 |
| Performance score | 0.85 (or 85%) |
| No. of errors committed | 15 (i.e., 7 + 5 + 3) |
| Types of pronunciation errors | Wrong pronunciation of words with |
| committed | sounds /fri/ and /d/ |
| Task on which maximum errors | Task for reading aloud the |
| were committed | sentence “The quick brown fox |
| | jumps over the lazy dog.” |
| Average time taken per task | 2.5 minutes |
| Maximum time taken on a task | 3.5 minutes |
| Minimum time taken on a task | 2 minutes |

Post evaluating the spoken language skills of the user on the second training content, in an embodiment, the processor 202 may determine a performance score of the user on the second training content in a manner similar to that described in step 308. Thereafter, the processor 202 may compare the performance scores of users in each user group, as discussed further.

At step 316, the performance scores of the user and the other users on the tasks from the second training content are compared. In an embodiment, the processor 202 is configured to compare the performance scores of the users in each user group. Thus, the processor 202 may compare the performance score of the user with the other users in the same user-group. Thereafter, in an embodiment, the processor 202 may provide a user with a performance report containing comparative statistics (on the each task from the one or more tasks in the second training content) of the user with respect to the other users in the user's user-group and/or social networking friend circle.

Post comparing the performance scores of the users in each user group, in an embodiment, the processor 202 may update the user profile of each user (in a manner similar to that described in step 308). In an embodiment, the processor 202 may update the user profile of each user when the user has completed all the tasks within the second training content. Alternatively, the processor 202 may update the user profile of each user simultaneously as the user attempts each task within the second training content, based on the spoken language evaluation of the user on that task. In an embodiment, the processor 202 may update the user profile of each user in a manner similar to that described in step 308. Further, the processor 202 may provide a notification to each user, through the user interface, upon the updation of the user profile of the user. In an embodiment, through the user interface, the processor 202 may provide the user with an option to review/update the training goals of the user.

Further, in an embodiment, the processor 202 may transmit an aggregate performance report of each user-group to the expert/trainer. A person skilled in the art would appreciate that the aggregate performance report may correspond to a user-group level, a regional/national level, or an individual user-level. Further, the aggregate performance report may also correspond to a group of users with the same mother tongue/dialect. The aggregate performance report may include statistics related to the performance of the users such as types of errors committed by the users and the spoken language skills of the users, for example, basic phone pronunciation, syllable pronunciation, syllable concentration, co-articulation, etc. Based on such aggregate performance reports, the expert/trainer may upload a fresh training content or suggest a training content from the repository of training contents.

Post the updation of the user profile of the users (i.e., step 308), steps 310 to 316 are repeated in a similar manner for each user till the user resigns from the training, the training goals of the user are achieved, or after a pre-determined time has elapsed.

A person skilled in the art would appreciate that the user profile as well as the user groups may be dynamic in nature. As the users learn and progress in the spoken language training, the user profiles are updated and the users are re-categorized into newer user groups to meet current training needs of the users. Further, in an embodiment, the user may specify his/her training needs through the user interface. For example, based on comparison with other users, the user may realize that he/she needs to improve on one or more aspects of his/her spoken language skills. Accordingly, the user may specify such training needs to the application server 102 through the user interface. Further, in an embodiment, the user may select a training content from the repository of training contents through the user interface to meet his/her training needs.

A person skilled in the art would also understand that the aspect of the categorization of the users may be optional. Accordingly, in an embodiment, the users may not be categorized in the one or more groups. Instead, each user may receive training content tailored for the user's specific training needs. In such a scenario, the expert/trainer may directly interact with the users and provide the user with relevant training content. In addition, the user may also select a relevant training content from the repository of training contents through the user interface.

FIGS. 4A, 4B, 4C, 4D, 4E, 4F, and 4G illustrate examples of the user interfaces presented on the user-computing device (e.g., 108a) for spoken language training of the user, in accordance with at least one embodiment.

Referring to FIG. 4A, the user interface (depicted by 402) may be presented to the user if the user chooses to compare a temporal progression of his/her performance with that of the other users on the one or more tasks. Accordingly, as shown in FIG. 4A, the user interface (depicted by 402) may provide the user with various options (as depicted in the region 404) such as, but not limited to, selecting users, selecting task types, selecting time intervals, and so on.

In case the user provides an input for assessing his/her own temporal progression on the training over a time period through the user interface 402, the user is provided with his/her performance statistics over a user-selected period of time and for a user-selected type of tasks through the user interface 402. Further, in an embodiment, through the user-selection drop-down depicted in the region 404, the user may select two or more other users and exclude himself/herself in the list of selected users. In such a scenario, the user may be presented with performance statistics related to the temporal progression of the so selected users through the user interface 402.

In an embodiment, the user may select himself/herself and one or more other users through the user selection drop-down depicted in the region 404. For example, as shown in FIG. 4A, the user selects the options “You” and “User A” from the select user drop-down. Further, the user selects the task type “Pronunciation” and the time interval “Past week” from the respective drop-down lists. Based on such inputs received from the user through the various options (such as those depicted in the region 404), performance statistics related to the temporal progression of the user and the other user/users are presented to the user through the user interface (depicted by 402). Examples of the various performance statistics presented to the user include graphs 406, 408, 410, 412, and 414.

The graph 406 depicts a monthly summary of the performance of the user and that of the other user (e.g., User A). Trend lines 403a and 403b depict the temporal progression of the User A with respect to the current user respectively, with respect to the number of tasks attempted during the previous month. As is evident from the trend lines 403a and 403b, the current user started the training two weeks after the User A. Further, the current user attempted more tasks than the User A in the third week, while the performance of the current user declined with respect to the User A in the fourth week of the month (i.e., the previous week). Such comparisons may help the users in tracking their performance with respect to the other users and catching up if needed.

The graph 408 depicts a comparison of the user's performance with respect to the other user (e.g., User A) in each day of the previous week. As is evident from the graph 408, the User A attempted more number of tasks than the current user throughout the week. Further, the performance of the User A peaked on Day 4, while the performance of the current user was the best on Day 5.

The graph 410 depicts a comparison of an average performance score of the user with respect to the other user (e.g., User A) during the previous week. As regards the average performance score during the week, trend lines 403c and 403d depict the temporal progression of the User A and current user respectively. As is evident from the trend lines 403c and 403d, the average performance score of the User A and the current user improved through the week, with their performances peaking at about the same time.

The graph 412 depicts a comparison of an average task completion time of the user with respect to the other user (e.g., User A) during the previous week. As regards the average task completion time during the week, trend lines 403e and 403f depict the temporal progression of the User A and current user, respectively. As is evident from the trend lines 403e and 403f, the average task completion time of the User A and the current user were very close to each other throughout the week.

The graph 414 depicts a comparison of a number of errors committed by the user with respect to the other user (e.g., User A) during the previous week. As regards the number of errors committed during the week, trend lines 403g and 403h depict the temporal progression of the User A and current user respectively. As is evident from the trend lines 403h, the number of errors committed by the current user declined steadily through the first five days of the week and increased on the last two days. On the other hand the trend line 403g illustrates that the number of errors committed by the User A declined through the first half of the week and increased towards the last half of the week.

A person skilled in the art would appreciate that the various performance statistics graphs (depicted by 406, 408, 410, 412, and 414) are for the purpose of illustration. Further, the various selection options depicted in the region 404 are also for the purpose of illustration. The disclosure may be implemented using various other graphs and selection options without departing from the spirit of the disclosure.

Referring to FIG. 4B, the user interface (depicted by 416) may be presented to the user if the user chooses to challenge the other users on a particular task (say, a task “N”). Accordingly, as shown in FIG. 4B, the user interface (depicted by 416) may provide the user an option to choose users that he/she wants to challenge on the task (i.e., the task “N”). The user may choose one or more other users from his/her user-group (or learning group) such as User A, User B, User C, and User D. In addition, the user may also choose one or more other users from his/her social circle including Facebook friends (such as User X, User Y, and User Z), LinkedIn connections, connections on Twitter, connections on MySpace, and so on. Once the user selects the other users, the user may confirm his/her selection (e.g., by clicking on the OK button).

Referring to FIG. 4C, the user interface (depicted by 418) may be presented to the user if the user chooses to compete with the other users on a particular task (say, the task “N”) with respect to the time taken to complete that task and/or a performance score attained on the task. Accordingly, as shown in FIG. 4C, the user interface (depicted by 418) may provide the user an option to choose users that he/she wants to compete with on the task (i.e., the task “N”). The time taken by the other users to complete the task and the performance score attained by the other users on the task may also be displayed on the user interface (depicted by 418). For instance, as illustrated in FIG. 4C, the time taken by User A to complete the task “N” was 2.5 minutes. Further, User A achieved the performance score of 125 points on the task “N”. Accordingly, the user may want to compete with User A, if the user so desires.

Referring to FIG. 4D, the user interface (depicted by 420) may be presented to the user if the user chooses to select tasks that have been attempted by the other users. Accordingly, as shown in FIG. 4D, the user interface (depicted by 420) enumerates the tasks completed by the other users. For instance, User B has attempted task B, task C, and task D, while User Y has attempted task A and task B. Further, as discussed in step 312, the users may associate a difficulty level with each task that they attempt. In an embodiment, the user interface (depicted by 420) may also display the difficulty level assigned to each task by the other users. For example, as shown in FIG. 4D, task B is assigned a medium difficulty level by User Y and an easy difficulty level by User B. Thus, the user may wish to attempt task B, if the user so desires.

Referring to FIG. 4E, the user interface (depicted by 422) may be presented to the user if the user wishes to collaborate on a particular task (say, the task “N”) with the other users. Accordingly, as shown in FIG. 4E, the user interface (depicted by 422) may prompt the user to enter comments related to the task. For example, the user may want to clarify concepts or confirm understanding on the task “N”. Hence, the user may provide his/her specific queries for the other users as comments on the task. Again, as shown in FIG. 4E, the user interface (depicted by 422) provides the user with an option to select the other users from his/her user group (or learning group) and/or social networking circle. The selected users may then receive the comments provided by the user and thereafter provide comments/clarifications on the task. Further, in an embodiment, through the user interface 422, the user may also seek help/guidance from the expert/trainer, if the user so desires.

Referring to FIG. 4F, the user interface (depicted by 424) may be presented to the user if the user wishes to view the leader-board associated with a particular task (e.g., the task “N”). As shown in FIG. 4F, the user interface (depicted by 424) enlists top 5 performers on the task “N” based on the performance score of the users on the task and the time taken by the users to complete the task. The rank of the user (e.g., rank 26), the performance score of the user (e.g., 85 points), and the time taken by the user to complete the task (e.g., 3.8 minutes) may also be displayed in the user interface (depicted by 424). As discussed with reference to step 316, the users may be assigned points (i.e., the performance score) based on the number and/or the types or errors committed to the task, the time taken to complete the task, and so on.

Referring to FIG. 4G, the user interface (depicted by 426) may be presented to the user when the user wishes to attempt a particular task (for e.g., the task “N”) from a received training content (e.g., the training module-2). For instance, the task “N” requires the user to read aloud a given sentence thrice. Further, the user interface (depicted by 426) may also provide live-feeds relevant to the current task (i.e., the task “N”). For example, the live feeds may include the average time taken on the task, time taken by the other users on the task, number/type of mistakes committed by the other users and so on.

A person skilled in the art would appreciate that the user interfaces (depicted by 402, 416, 418, 420, 422, 424, and 426) are for the purpose of illustrative examples. The scope of the disclosure is not limited to such user interfaces. The disclosure may be implemented through other similar/dissimilar user interfaces.

Though the disclosure has been explained with reference to imparting spoken language training to one or more users, a person skilled in the art would appreciate that the scope of the disclosure should not be limited to imparting spoken language training. The disclosure may be implemented for imparting any type of training to the one or more users without departing from the spirit of the disclosure.

The disclosed embodiments encompass numerous advantages. Various embodiments of the disclosure provide for imparting spoken language training to one or more users. The first training content transmitted to the user is based on the user profile of the user (step 304). The user profile may include demographic details of the user such as age, gender, mother tongue, educational/professional details, region, nationality, and so on. Thus, as such, the first training content may be relevant to the user. Further, the user may be evaluated on the spoken language skills of the user based on the speech input received from the user on the first training content (step 306). As discussed, the granularity of the spoken language evaluation may be both at a lower-level (i.e., at the level of individual phones, syllables, etc.) and a higher-level (i.e., prosody, intonation, spoken grammar, spoken fluency, etc.). Thus, spoken language evaluation of the user may be comprehensive. The updation of the user profile based on such evaluation may ensure that the user profile accurately reflects the current training needs of the user.

Further, the user is categorized in one of the one or more user-groups based on the updated user profile, where each user-group includes users with similar profile (step 310). Thereafter, the users belonging to the same user-group may be transmitted the second training content, which may be relevant for the common training needs of the users categorized in the particular user-group. Further, the experts/trainers may be provided with aggregate-level performance reports for the users of each user-group. Based on such performance reports, the experts/trainers may contribute to the enhancement of the repository of training contents. This may lead to an improvement in the quality of the training content.

Another advantage of the disclosure lies in the gamification of the spoken language training through the aspect of user interaction. As discussed, while attempting the one or more tasks in the second training content, the user may interact with the other users, i.e., the users belonging to the user group of the user and/or the users belonging to the social networking friend circle of the user. The various aspects of user interaction (discussed in step 314) may act as a source of intrinsic motivation and drive for the users to outperform their friends/peers.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or other similar devices that enable the computer system to connect to databases and networks, such as, LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or only hardware, or using a varying combination of the two techniques. The disclosure is independent of the programming language and the operating system used in the computers. The instructions for the disclosure can be written in all programming languages, including, but not limited to, ‘C’, ‘C++’, ‘Visual C++’ and ‘Visual Basic’. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for imparting spoken language training have been disclosed. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for imparting a spoken language training, the method comprising:
performing, by one or more processors, a spoken language evaluation of a speech input received from a user on a first training content, wherein the spoken language evaluation corresponds to an evaluation of the speech input with respect to a pronunciation, a prosody, an intonation, a spoken grammar, and a spoken fluency;
categorizing, by the one or more processors, the user in a user group from one or more user groups based on the spoken language evaluation and a user profile of the user;
transmitting, by the one or more processors, a second training content to the user based at least on the categorization and the spoken language evaluation, wherein the second training content comprises one or more tasks for the spoken language training of the user,
wherein the user interacts with at least one other user, the interaction comprising:
comparing a temporal progression of the user with the at least one other user on the one or more tasks,
challenging the at least one other user on a task from the one or more tasks, and
selecting the task from the one or more tasks based at least on a difficulty level of the task assessed by the at least one other user, and
wherein the at least one other user belongs to at least the user group.

2. The method of claim 1, wherein the at least one other user belongs to a social networking group of the user, wherein the social networking group of the user comprises at least the user's connections on one or more communication platforms including at least one of a social networking website, a chat/messaging application, a web-blog, a community portal, an online community, or an online interest group, wherein the user adds the at least one other user to the social networking group during the spoken language training.

3. The method of claim 1, wherein the user profile comprises at least one of an age of the user, a gender of the user, a mother tongue of the user, a region to which the user belongs, a nationality of the user, an educational background of the user, a professional background of the user, a performance score of the user on a training content, types of spoken language errors committed by the user, a learning curve associated with the user, or training goals of the user.

4. The method of claim 1, wherein performing the spoken language evaluation further comprises analyzing, by the one or more processors, the speech input using one or more speech processing techniques comprising at least one of a force-aligned automatic speech recognition, a syllable-level speech analysis, a pitch contour analysis, or a signal processing.

5. The method of claim 1 further comprises updating, by the one or more processors, the user profile based on the spoken language evaluation.

6. The method of claim 1, wherein the first training content is created based on the user profile.

7. The method of claim 1, wherein the second training content is based on a training level of the user, which is determined based on the user group of the user or training goals of the user, wherein the second training content is further based on a training sub-level of the user within the training level, which is determined based on the spoken language evaluation of the user, and wherein the training sub-level of the user corresponds to a number/type of spoken language errors committed by the user.

8. The method of claim 1, wherein the second training content is recommended by an expert based on at least one of the user group of the user or the spoken language evaluation of the user.

9. The method of claim 1, wherein the interaction further comprises the user competing with the at least one other user on at least one of a performance score or a time taken, on the task.

10. The method of claim 9, wherein the competing corresponds to a passive gaming interaction of the user with the at least one other user.

11. The method of claim 1, wherein a combination of the comparing, the challenging, and the selecting corresponds to an active gaming interaction of the user with the at least one other user.

12. The method of claim 1 further comprising re-categorizing, by the one or more processors, the user in a new user group from the one or more user groups based on the spoken language evaluation of the user on the second training content.

13. A system for imparting a spoken language training, the system comprising:
one or more processors configured to:
perform a spoken language evaluation of a speech input received from a user on a first training content, wherein the spoken language evaluation corresponds to an evaluation of the speech input with respect to a pronunciation, a prosody, an intonation, a spoken grammar, and a spoken fluency;
categorize the user in a user group from one or more user groups based on the spoken language evaluation and a user profile of the user;
transmit a second training content to the user based at least on the categorization and the spoken language evaluation, wherein the second training content comprises one or more tasks for the spoken language training of the user,
wherein the user interacts with at least one other user, the interaction comprising:
comparing a temporal progression of the user with the at least one other user on the one or more tasks,
challenging the at least one other user on a task from the one or more tasks, and
selecting the task from the one or more tasks based at least on a difficulty level of the task assessed by the at least one other user, and
wherein the at least one other user belongs to at least the user group.

14. The system of claim 13, wherein the at least one other user belongs to a social networking group of the user, wherein the social networking group of the user comprises at least the user's connections on one or more communication platforms including at least one of a social networking website, a chat/messaging application, a web-blog, a community portal, an online community, or an online interest group, wherein the user adds the at least one other user to the social networking group during the spoken language training.

15. The system of claim 13, wherein the user profile comprises at least one of an age of the user, a gender of the user, a mother tongue of the user, a region to which the user belongs, a nationality of the user, an educational background of the user, a professional background of the user, a performance score of the user on a training content, types of spoken language errors committed by the user, a learning curve associated with the user, or training goals of the user.

16. The system of claim 13, wherein to perform the spoken language evaluation, the one or more processors are further configured to analyze the speech input using one or more speech processing techniques comprising at least one of a force-aligned automatic speech recognition, a syllable-level speech analysis, a pitch contour analysis, or a signal processing.

17. The system of claim 13, wherein the one or more processors are further configured to update the user profile based on the spoken language evaluation.

18. The system of claim 13, wherein the first training content is created based on the user profile.

19. The system of claim 13, wherein the second training content is based on a training level of the user, which is determined based on the user group of the user or training goals of the user, wherein the second training content is further based on a training sub-level of the user within the training level, which is determined based on the spoken language evaluation of the user, and wherein the training sub-level of the user corresponds to a number/type of spoken language errors committed by the user.

20. The system of claim 13, wherein the second training content is recommended by an expert based on at least one of the user group of the user or the spoken language evaluation of the user.

21. The system of claim 13, wherein the interaction further comprises the user competing with the at least one other user on at least one of a performance score or a time taken, on the task.

22. The system of claim 21, wherein the competing corresponds to a passive gaming interaction of the user with the at least one other user.

23. The system of claim 13, wherein a combination of the comparing, the challenging, and the selecting corresponds to an active gaming interaction of the user with the at least one other user.

24. The system of claim 13, wherein the one or more processors are further configured to re-categorize the user in a new user group from the one or more user groups based on the spoken language evaluation of the user on the second training content.

25. A computer program product for use with a computing device, the computer program product comprising a non-transitory computer readable medium, the non-transitory computer readable medium stores a computer program code for imparting a spoken language training, the computer program code is executable by one or more processors in the computing device to:
perform a spoken language evaluation of a speech input received from a user on a first training content, wherein the spoken language evaluation corresponds to an evaluation of the speech input with respect to a pronunciation, a prosody, an intonation, a spoken grammar, and a spoken fluency;
categorize the user in a user group from one or more user groups based on the spoken language evaluation and a user profile of the user;
transmit a second training content to the user based at least on the categorization and the spoken language evaluation, wherein the second training content comprises one or more tasks for the spoken language training of the user,
wherein the user interacts with at least one other user, the interaction comprising:
comparing a temporal progression of the user with the at least one other user on the one or more tasks,
challenging the at least one other user on a task from the one or more tasks, and
selecting the task from the one or more tasks based at least on a difficulty level of the task assessed by the at least one other user, and
wherein the at least one other user belongs to at least the user group.

26. The computer program product of claim 25, wherein the at least one other user belongs to a social networking group of the user, wherein the social networking group of the user comprises at least the user's connections on one or more communication platforms including at least one of a social networking website, a chat/messaging application, a web-blog, a community portal, an online community, or an online interest group, wherein the user adds the at least one other user to the social networking group during the spoken language training.

27. The computer program product of claim 25, wherein the user profile comprises at least one of an age of the user, a gender of the user, a mother tongue of the user, a region to which the user belongs, a nationality of the user, an educational background of the user, a professional background of the user, a performance score of the user on a training content, types of spoken language errors committed by the user, a learning curve associated with the user, or training goals of the user.

28. The computer program product of claim 25, wherein the interaction further comprises the user competing with the at least one other user on at least one of a performance score or a time taken, on the task.

29. The computer program product of claim 28, wherein the competing corresponds to a passive gaming interaction of the user with the at least one other user.

30. The computer program product of claim 25, wherein a combination of the comparing, the challenging, and the selecting corresponds to an active gaming interaction of the user with the at least one other user.
